(19) United States
(12) Patent Application Publication
(10) Pub. No.: US 2025/0371372 A1
(43) Pub. Date: Dec. 4, 2025

(54) DISTRIBUTED TRAINING PROGRAM, METHOD, AND DEVICE

(71) Applicant: Fujitsu Limited, Kawasaki-shi (JP)

(72) Inventor: Shingo OKUNO, Kyoto (JP)

(73) Assignee: Fujitsu Limited, Kawasaki-shi (JP)

(21) Appl. No.: 19/297,029

(22) Filed: Aug. 12, 2025

Related U.S. Application Data
(63) Continuation of application No. PCT/JP2023/046541, filed on Dec. 26, 2023.

(30) Foreign Application Priority Data
Feb. 16, 2023 (JP) 2023-022504

(51) Int. Cl. G06N 3/098

(52) U.S. Cl. CPC G06N 3/098

(57) ABSTRACT

A distributed training device includes a processor that executes a procedure. The procedure includes: in distributed training in which a plurality of workers is in charge of training processing of each of a plurality of neural networks of multiple neural networks that integrate inference results of the plurality of neural networks and output a final inference result, detecting whether or not a failure has occurred in each of the plurality of workers, determining, when occurrence of a failure is detected in one or more first workers among the plurality of workers, whether or not to continue the distributed training using a second worker other than first workers among the plurality of workers, and in a case of continuing the distributed training, distributing training processing that the first worker is in charge of to the second worker, and continuing the distributed training.

### CROSS-REFERENCE TO RELATED APPLICATION

This application is a continuation application of International Application No. PCT/JP2023/046541, filed Dec. 26, 2023, which claims the benefit of priority of the prior Japanese Patent Application No. 2023-022504, filed on Feb. 16, 2023, the disclosure of which is incorporated herein by reference in its entirely.

### FIELD

The embodiments discussed herein are related to a distributed training program, a distributed training method, and a distributed training device.

### BACKGROUND

Conventionally, a technique related to distributed training in which machine learning of a machine learning model such as a neural network is executed by a plurality of nodes has been proposed. For example, a method of non-centralized distributed deep learning in a computing environment by one or more processors has been proposed. The method generates a list of neighboring nodes for each node in the plurality of nodes to create a first thread for continuous communication according to weight management operations and a second thread for continuous computation of gradients of each node. The method includes performing asynchronous distributed training of one or more machine learning models, in which one or more variables are shared between a first thread and a second thread.
[Related Patent Documents] Japanese National-Phase Publication (JP-A) No. 2022-511716

### SUMMARY

According to an aspect of the embodiments, in distributed training in which a plurality of workers is in charge of training processing of each of a plurality of neural networks of multiple neural networks that integrate inference results of the plurality of neural networks and output a final inference result, detecting whether or not a failure has occurred in each of the plurality of workers, determining, when occurrence of a failure is detected in one or more first workers among the plurality of workers, whether or not to continue the distributed training using a second worker other than first workers among the plurality of workers, and in a case of continuing the distributed training, distributing training processing that the first worker is in charge of to the second worker, and continuing the distributed training.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a schematic configuration of an information processing system according to the present embodiment.

FIG. 2 is a diagram for describing a specific example of a multiple neural network.

FIG. 3 is a diagram for describing an output of the multiple neural network.

FIG. 4 is a diagram for describing distributed training in data parallelism.

FIG. 5 is a diagram for describing a problem in a case in which a failure occurs in a worker in distributed training of the multiple neural network.

FIG. 6 is a diagram for describing a problem in a case in which a failure occurs in a worker in distributed training of the multiple neural network.

FIG. 7 is a functional block diagram of a management worker.

FIG. 8 is a diagram for describing continuation of distributed training in a remaining worker group.

FIG. 9 is a diagram for describing distribution of training data to a remaining worker group.

FIG. 10 is a diagram for describing a batch size per worker at the time of distributed training in data parallelism.

FIG. 11 is a diagram for describing calculation of a batch size for a continuation model.

FIG. 12 is a block diagram illustrating a schematic configuration of a computer that functions as a computer system.

FIG. 13 is a flowchart illustrating an example of a distributed training processing.

FIG. 14 is a flowchart illustrating an example of distribution processing.

FIG. 15 is a flowchart illustrating an example of determination processing in proxy worker processing.

FIG. 16 is a flowchart illustrating another example of the distributed training processing.

### DESCRIPTION OF EMBODIMENTS

Hereinafter, an example of an embodiment according to the disclosed technology will be described with reference to the drawings.

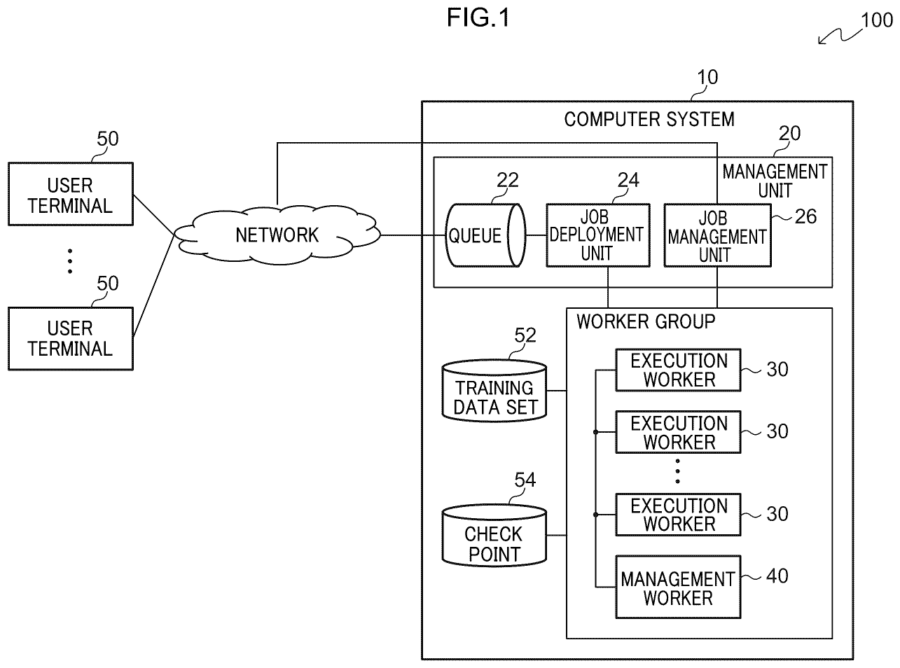

As illustrated in FIG. 1, an information processing system 100 according to the present embodiment includes a computer system 10 and a plurality of user terminals 50. The computer system 10 and each of the user terminals 50 are communicably connected to each other via a network. The information processing system 100 is a system that allocates a resource of the computer system 10 to a job input from a user via the user terminal 50 and executes the job using the allocated resource.

The user terminal 50 is an information processing terminal used by the user of the information processing system 100, and is implemented by, for example, a personal computer, a tablet terminal, a smartphone, or the like. The user terminal 50 receives a job input from the user and transmits the job to the computer system 10. The user terminal 50 receives an execution result of the job transmitted from the computer system 10, and presents an execution result to the user by displaying the execution result on a display device or the like.

In the present embodiment, the job is machine learning of a machine learning model. In particular, the present embodiment is directed to distributed training of a multiple neural network that integrates inference results of a plurality of neural networks and outputs a final inference result.

The computer system 10 includes one or more computers, and these computers function as a management unit 20 and a worker group. The computer system 10 includes a storage device, and the storage device stores a training dataset 52, which is a plurality of pieces of training data used for training of the machine learning model, and a checkpoint 54, which is information of the machine learning model in the latest state at the time of execution of training. The computer system 10 may be, for example, a high-performance computing system.

The management unit 20 includes a queue 22, a job deployment unit 24, and a job management unit 26. The queue 22 is a storage area in which jobs transmitted from the user terminal 50 are sequentially stored. The job deployment unit 24 extracts jobs one by one from the queue 22, allocates workers to execute the extracted jobs, and causes the workers to execute the jobs. The job management unit 26 acquires a job execution result by the worker and transmits the acquired execution result to the user terminal 50 via the network.

The worker group includes a plurality of workers. Here, the worker is a unit that executes an assigned job or a part of a job, and may be, for example, one or a plurality of computers or one or a plurality of processors. In the present embodiment, for convenience of description, a worker that executes distributed training will be described as an execution worker 30, and a worker that manages execution of a job by the execution worker 30 will be described as a management worker 40. In the following description, each execution worker 30 of the execution worker group that executes one job in a distributed manner is also referred to as a “worker k”. k is an identification number of the execution worker 30 included in the execution worker group, and k=0, 1, 2, . . . in the present embodiment.

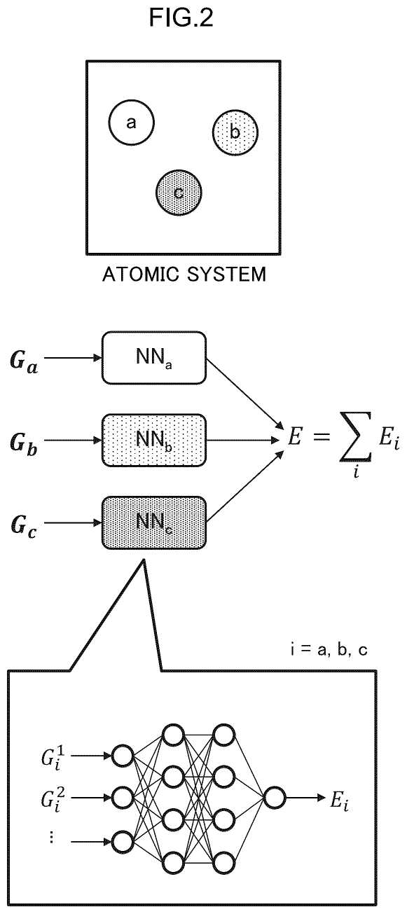

Here, a specific example of the multiple neural network will be described with reference to FIG. 2. FIG. 2 is an example of high-dimensional neural network potential (HDNNP), and is an example of a multiple neural network that calculates the potential energy of the entire atomic (molecular) system by machine learning. As illustrated in the upper diagram of FIG. 2, in a case in which the atomic system includes an atom i (i=a, b, and c), data Gᵢ is input to a neural network (NN)ᵢ related to the atom i as illustrated in the lower diagram of FIG. 2, and potential energy Eᵢ of the atom i is calculated. Then, the sum of Eᵢ is calculated as the potential energy E of the entire atomic system.

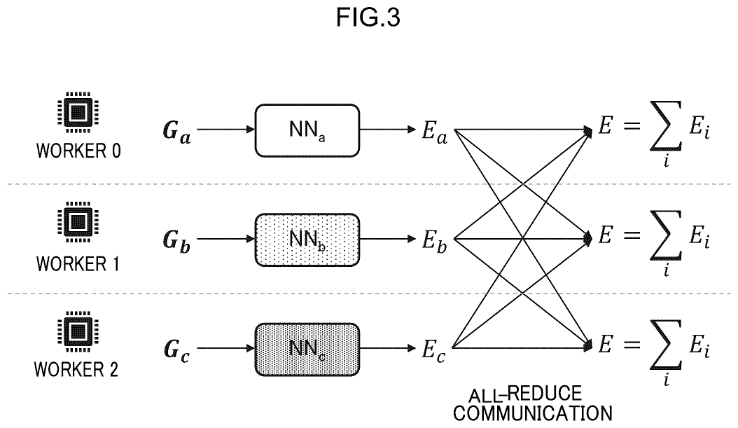

In parallelization of training of multiple neural networks, that is, distributed training, as illustrated in FIG. 3, an execution worker 30 (in the example of FIG. 3, a worker k and k=0, 1, and 2) is assigned to each neural network NNᵢ. Then, each worker k acquires calculation results from the other workers k by all-reduce communication, and calculates the sum of its own calculation result and the acquired calculation results of the other workers k.

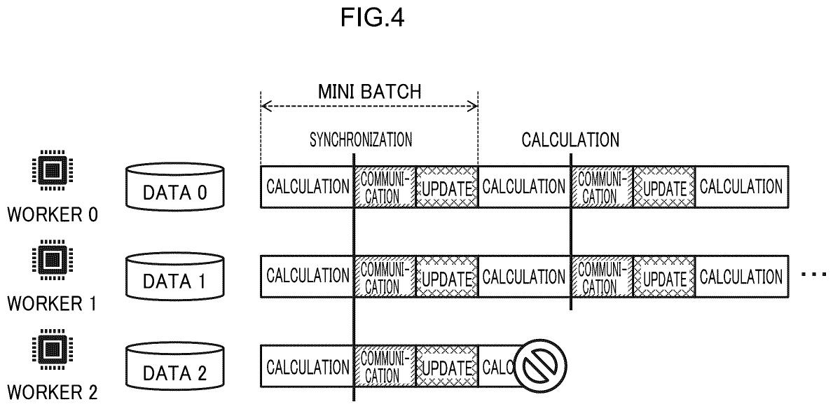

Next, in order to describe a problem in a case in which a failure occurs in a worker in distributed training of a multiple neural network, first, a case other than the multiple neural network will be described. For example, as illustrated in FIG. 4, a case is considered in which the same machine learning model is used in each worker k, a training dataset is divided between workers, and distributed training in data parallelism is performed. In the distributed training in data parallelism, for example, the training data is divided into units of mini-batches, and each worker calculates a gradient for reducing the loss of the neural network for each mini-batch. Then, by performing communication after synchronization between workers, an average of gradients calculated by each worker k is calculated, and the weight of the neural network is updated. In this case, for example, when a failure occurs in the worker 2, the worker 2 in which the failure has occurred leaves the distributed training, and a calculation result of the worker 2 is not reflected, so that the training accuracy may be deteriorated. However, training by the worker 0 and the worker 1 can be continued.

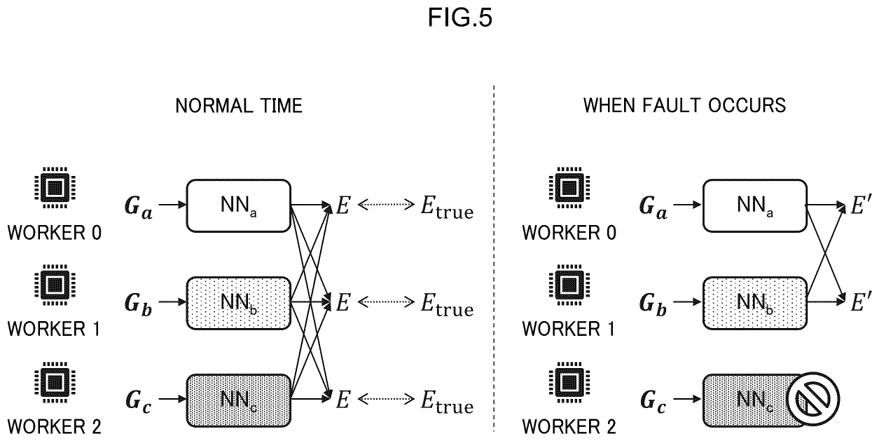

However, in the case of the multiple neural network, as illustrated in FIG. 5, since a teacher value (correct data) exists with respect to the sum of outputs of the respective neural networks, it is not possible to calculate the loss when a failure occurs. Specifically, at the normal time, the loss is calculated by comparing a predicted value E=ΣᵢEᵢ calculated by communication between workers with a teacher value Eₜᵣᵤₑ. However, for example, when a failure occurs in the worker 2, since a predicted value E_{c} of NN_{c} is not included in a predicted value E′ calculated from a predicted value Eₐ of NNₐ and a predicted value E_{b} of NN_{b}, an appropriate comparison with the teacher value Eₜᵣᵤₑ cannot be performed, and a loss cannot be calculated.

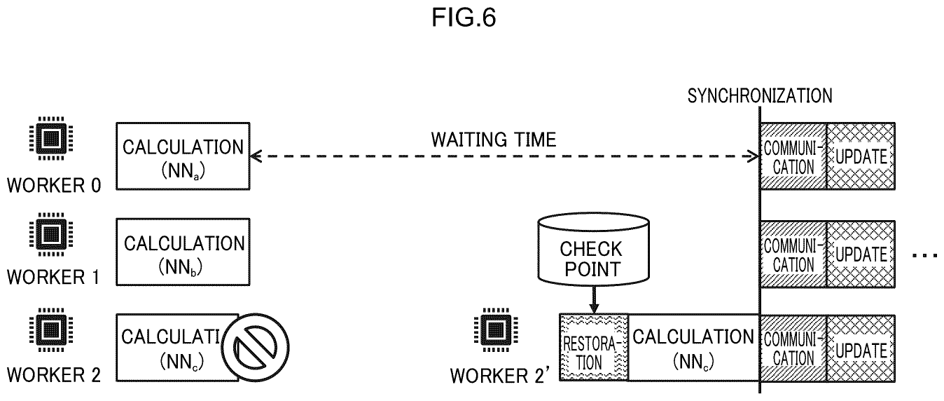

In this case, in order to continue distributed training, a new worker to be a proxy (hereinafter referred to as a “proxy worker”) of a worker who has left the distributed training (hereinafter referred to as a “left worker”) is secured. Then, it is conceivable to restart the distributed training with the proxy worker in addition to the remaining workers (hereinafter, referred to as a “remaining worker”) in which no failure has occurred. For example, as illustrated in FIG. 6, when the worker 2 leaves, a worker 2′ is secured as a proxy worker, and the latest state of NN_{c} is restored from the checkpoint 54 as a model used by the worker 2′. The worker 2′ then calculates a gradient using NN_{c}. Thereafter, distributed training is executed by an execution worker group obtained by adding a worker 2′ to the worker 0 and the worker 1.

In this manner, in a case in which the left worker is replaced with a proxy worker, a waiting time occurs in the distributed training until the proxy worker is ready. In particular, in an environment where it is difficult to secure a proxy worker, for example, in a case in which a job in the computer system 10 is congested and there is no vacant execution worker 30, the waiting time increases.

Therefore, in the present embodiment, the distributed training is continued by a remaining worker group by dividing the training processing of the left worker among the remaining worker group. Hereinafter, the function of the management worker 40 for implementing this processing will be described in detail. Note that the management worker 40 is an example of a distributed training device of the disclosed technology.

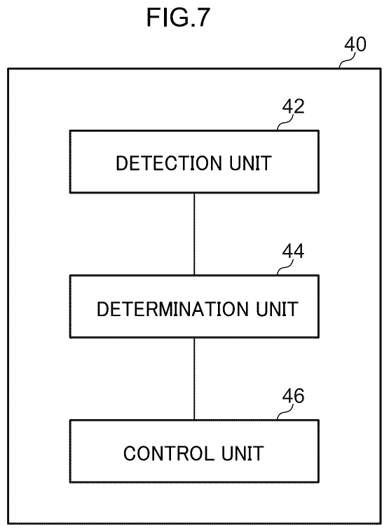

One management worker 40 is provided for an execution worker group that executes one job. As illustrated in FIG. 7, the management worker 40 functionally includes a detection unit 42, a determination unit 44, and a control unit 46.

The detection unit 42 detects whether or not a failure has occurred in each of the execution workers 30. For example, the detection unit 42 periodically receives a keep-alive from each execution worker 30, thereby performing alive monitoring of each execution worker 30. The detection unit 42 detects the occurrence of a failure for the execution worker 30 who has not sent a keep-alive for equal to or longer than a certain period of time. Upon detecting the occurrence of the failure, the detection unit 42 notifies the determination unit 44 of the identification number of the execution worker 30 in which the failure has occurred.

When the occurrence of a failure has been detected in one or more execution workers 30 in the execution worker group that executes one job, the determination unit 44 determines whether or not to continue distributed training for the execution worker 30 for which the occurrence of a failure has not been detected, that is, the remaining worker group, in the execution worker group. Specifically, the determination unit 44 determines to continue the distributed training by the remaining worker group in a case in which the time required to secure the execution worker 30 in which the failure is detected, that is, the proxy worker to be a proxy of the left worker is equal to or longer than a threshold.

Specifically, for example, the determination unit 44 acquires the degree of congestion by executing a command for acquiring the degree of congestion of a job in the computer system 10, and estimates the time required from the request for the proxy worker to the securing on the basis of the acquired degree of congestion. In a case of a system that returns a predicted time at which the proxy worker is secured in response to a request for the proxy worker, the determination unit 44 may estimate a time required from requesting for the proxy worker to securing of the proxy worker from the predicted time. The determination unit 44 may set the threshold as a predetermined time or as an estimated value of a training time that increases when the distributed training is continued for the remaining worker group. The determination unit 44 calculates an estimated value of the increasing training time on the basis of, for example, the processing capability of the execution worker 30, the size of the target machine learning model, the size of the training data, and the like. The determination unit 44 notifies the control unit 46 of a determination result as to whether or not to cause the remaining worker group to continue the distributed training.

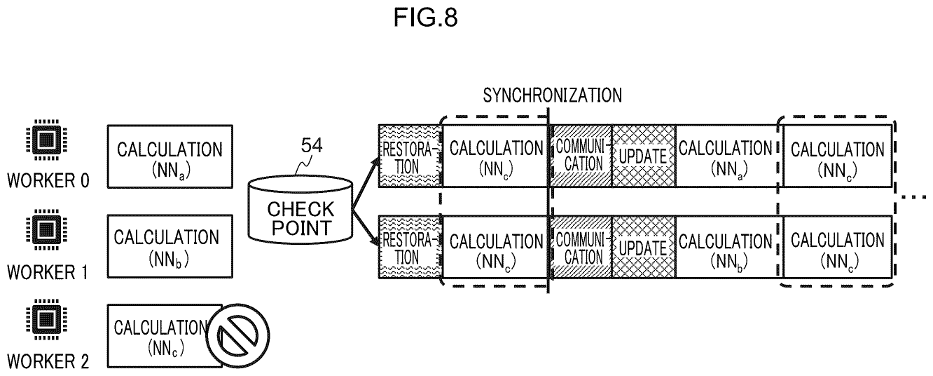

The control unit 46 controls each of the execution workers 30 to execute training processing for which it is in charge. Upon being notified from the determination unit 44 of a determination result indicating to cause the remaining worker group to continue the distributed training, the control unit 46 performs setting so that the training processing for which the left worker is in charge is distributed to each of the remaining workers, and that the remaining workers continue the distributed training. Specifically, as illustrated in FIG. 8, in a case in which the worker 2 has left, the control unit 46 restores the latest state of NN_{c} from the checkpoint 54 as a model used by the worker 0 and the worker 1. Hereinafter, the NN used by the left worker that has been restored for use by the remaining worker is also referred to as a “continuation model”. Then, the control unit 46 causes the worker 0 and the worker 1 to calculate the gradient using the restored NN_{c}. The control unit 46 sets the subsequent all-reduce communication to be performed between the worker 0 and the worker 1, and sets the worker 0 to execute the calculation of NNₐ and the calculation of NN_{c} and the worker 1 to execute the calculation of NN_{b} and the calculation of NN_{c}. Note that the worker 2 is an example of a first worker, and the worker 0 and the worker 1 are examples of a second worker.

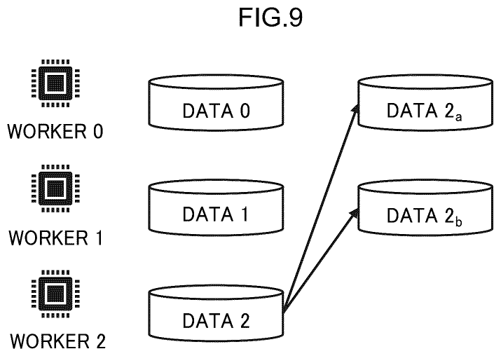

As illustrated in FIG. 9, the control unit 46 divides a portion of the training dataset 52 allocated to the left worker among the remaining workers. In the example of FIG. 9, the data 2 allocated to the left worker is divided into data 2a and data 2b, and the data 2a is distributed to the worker 0 and the data 2_{b} is distributed to the worker 1. The control unit 46 performs setting so as to calculate the gradient by inputting the data distributed from the left worker to the remaining worker to the restored NN_{c}. That is, the control unit 46 performs setting so that, in the worker 0, each mini-batch obtained by dividing the data 0 into a predetermined batch size is input to NNₐ to perform calculation, and each mini-batch obtained by dividing the data 2a into a predetermined batch size is input to NN_{c} to perform calculation. Similarly, the control unit 46 performs setting so that, in the worker 1, each mini-batch obtained by dividing the data 1 into a predetermined batch size is input to NN_{b} to perform calculation, and each mini-batch obtained by dividing the data 26 into a predetermined batch size is input to NN_{c} to perform calculation.

Thus, as illustrated in FIG. 8, the remaining workers share and execute the training processing that the left worker has been in charge of (in the example of FIG. 8, calculation of NN_{c} indicated by a broken line portion) that the left worker has been in charge of in parallel, so that the increase in the training time can be minimized.

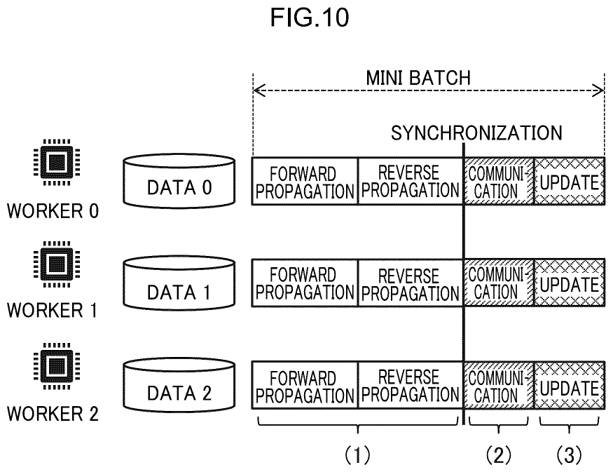

Here, as illustrated in FIG. 10, when the batch size per worker at the time of distributed training in data parallelism is s, each worker k calculates a gradient in units of mini-batches (the number of data s) ((1) in FIG. 10). Then, an average value of gradients is calculated between workers by all-reduce communication ((2) in FIG. 10), and each worker updates the model using the calculated average value of gradients ((3) in FIG. 10). As described above, since the calculated gradient is an average value between workers, the batch size in the entire distributed training is proportional to the number of workers executing the distributed training.

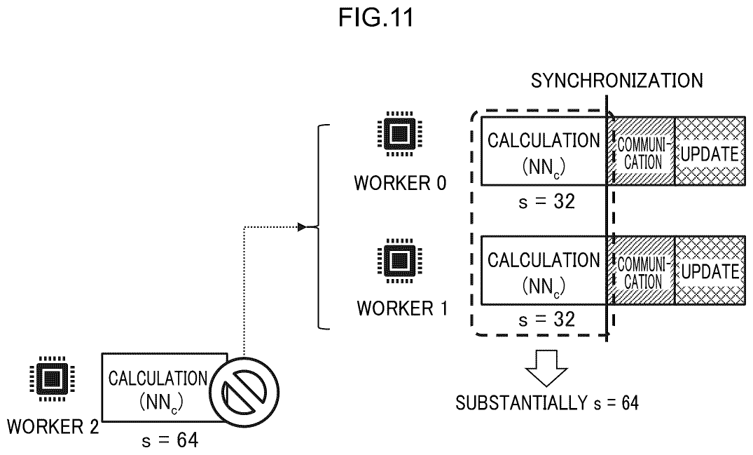

Therefore, the control unit 46 sets the batch size of the entire remaining workers for the continuation model to be the same as the batch size per left worker. For example, as illustrated in FIG. 11, in a case in which the batch size per worker is s=64 and the number of remaining workers is n=2, the control unit 46 sets the batch size per remaining worker for the continuation model to s/n=32. Thus, by averaging the gradients by all-reduce communication between the worker 0 and the worker 1, the substantial batch size for the entire remaining workers with respect to the continuation model is s=64.

Upon being notified from the determination unit 44 of a determination result indicating not to cause the remaining worker group to continue the distributed training, the control unit 46 temporarily interrupts the distributed training and requests the job deployment unit 24 to secure a proxy worker. When the proxy worker is secured, as described with reference to FIG. 6, the control unit 46 replaces the left worker and the proxy worker, that is, resumes the distributed training using the remaining worker and the proxy worker. Note that the proxy worker is an example of a third worker.

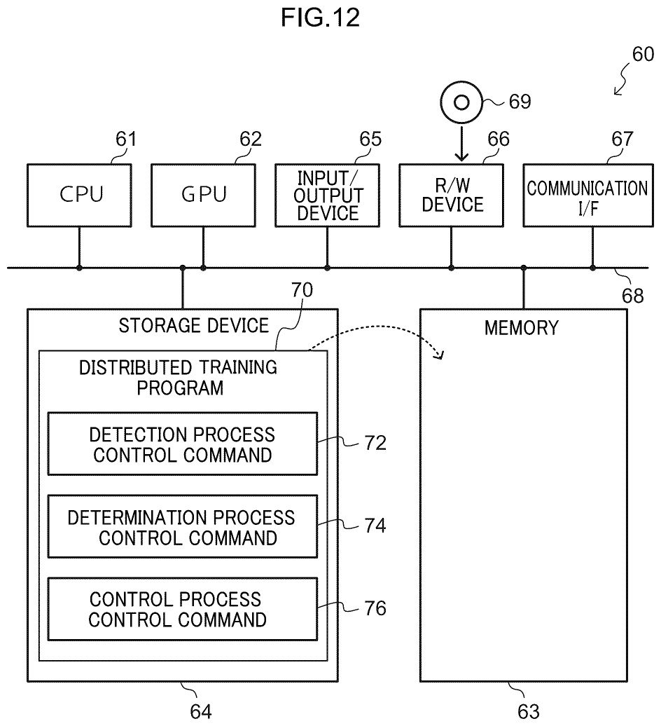

The computer system 10 is implemented by, for example, a computer 60 as illustrated in FIG. 12. The computer 60 includes a central processing unit (CPU) 61, a graphics processing unit (GPU) 62, a memory 63 as a temporary storage area, and a non-volatile storage device 64. The computer 60 includes an input/output device 65 such as an input device and a display device, and a read/write (R/W) device 66 that controls reading and writing of data with respect to the storage medium 69. The computer 60 further includes a communication interface (I/F) 67 connected to a network such as the Internet. The CPU 61, the GPU 62, the memory 63, the storage device 64, the input/output device 65, the R/W device 66, and the communication I/F 67 are connected to each other via a bus 68.

The storage device 64 is, for example, a hard disk drive (HDD), a solid state drive (SSD), a flash memory, or the like. The storage device 64 as a storage medium stores a distributed training program 70 for causing the computer 60 to function as the management worker 40 of the computer system 10. The storage device 64 includes programs for implementing the functions of the management unit 20 and the execution worker 30 in addition to the distributed training program 70, but a detailed description thereof will be omitted in the present embodiment. The distributed training program 70 has a detection process control command 72, a determination process control command 74, and a control process control command 76.

The CPU 61 reads the distributed training program 70 from the storage device 64, loads the program into the memory 63, and sequentially executes control commands included in the distributed training program 70. The CPU 61 operates as the detection unit 42 illustrated in FIG. 7 by executing the detection process control command 72. The CPU 61 operates as the determination unit 44 illustrated in FIG. 7 by executing the determination process control command 74. The CPU 61 operates as the control unit 46 illustrated in FIG. 7 by executing the control process control command 76. Thus, the computer 60 that has executed the distributed training program 70 functions as the management worker 40 of the computer system 10. The CPU 61 that executes the program is hardware. A part of the program may be executed by the GPU 62.

The functions implemented by the distributed training program 70 may be implemented by, for example, a semiconductor integrated circuit, more specifically, an application specific integrated circuit (ASIC), a field-programmable gate array (FPGA), or the like.

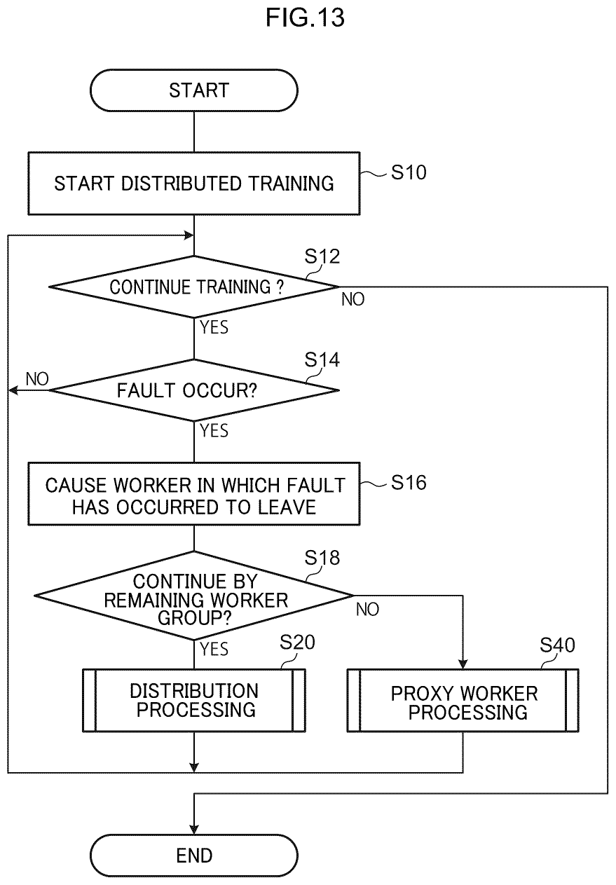

Next, an operation of the information processing system 100 according to the present embodiment will be described. When a job instructing execution of distributed training of a multiple neural network is input from the user terminal 50 to the computer system 10, the job deployment unit 24 deploys the execution worker 30 and the management worker 40 for executing the job. The management worker 40 executes distributed training processing illustrated in FIG. 13. The distributed training processing is an example of a distributed training method of the disclosed technology.

In step S10, the control unit 46 causes an execution worker group in charge of distributed training to start distributed training of the multiple neural network. Next, in step S12, the control unit 46 determines whether or not to continue training. In a case in which the predetermined end condition is not satisfied, for example, in a case in which the number of epochs of training has reached a predetermined number, in a case in which the loss has become equal to or less than a predetermined value, or in a case in which the loss has converged, it is determined to continue training, and the processing proceeds to step S14.

In step S14, the detection unit 42 determines whether or not a failure has occurred in any of the execution workers 30 that executes distributed training. In a case in which a failure has occurred in any of the execution workers 30, the process proceeds to step S16, or in a case in which no failure has occurred in any of the execution workers 30, the processing returns to step S12. In step S16, the control unit 46 causes the execution worker 30 in which occurrence of a failure is detected to leave the execution worker group that executes the distributed training.

Next, in step S18, the determination unit 44 determines whether or not to cause the remaining worker group to continue distributed training. For example, in a case in which the time required to secure the proxy worker is equal to or more than the threshold, it is determined that the distributed training by the remaining worker group is to be continued, the process proceeds to step S20, and the distribution processing is executed. On the other hand, in a case in which the time required to secure the proxy worker is less than the threshold, it is determined that the distributed training by the remaining worker group is not continued, the processing proceeds to step S40, and the proxy worker processing is executed.

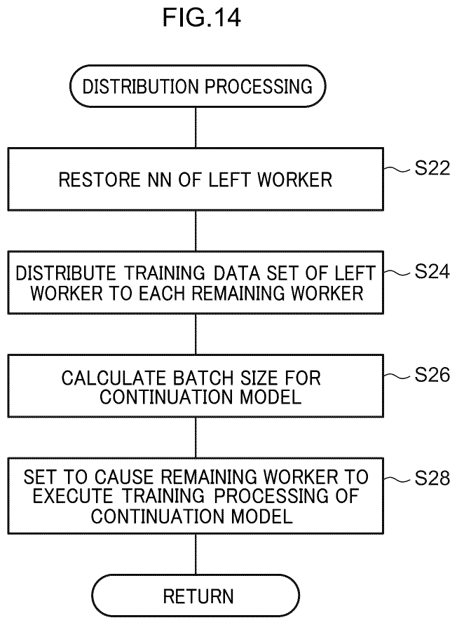

Here, the distribution processing will be described with reference to FIG. 14.

In step S22, the control unit 46 restores the latest state of the model (neural network) used by the left worker from the checkpoint 54 as the continuation model used by each remaining worker. Next, in step S24, the control unit 46 distributes a portion of the training dataset 52 allocated to the left worker to each remaining worker.

Next, in step S26, the control unit 46 calculates the batch size of each remaining worker for the continuation model so that the batch size of the entire remaining workers for the continuation model becomes the same as the batch size per left worker. Next, in step S28, the control unit 46 sets each remaining worker to execute the training processing by applying the mini-batch obtained by dividing the data distributed in step S24 by the batch size calculated in step S26 to the continuation model. Then, the distribution processing is ended, the processing returns to the distributed training processing (FIG. 13), and the processing returns to step S12. Thus, the distributed training by the remaining worker group is continued.

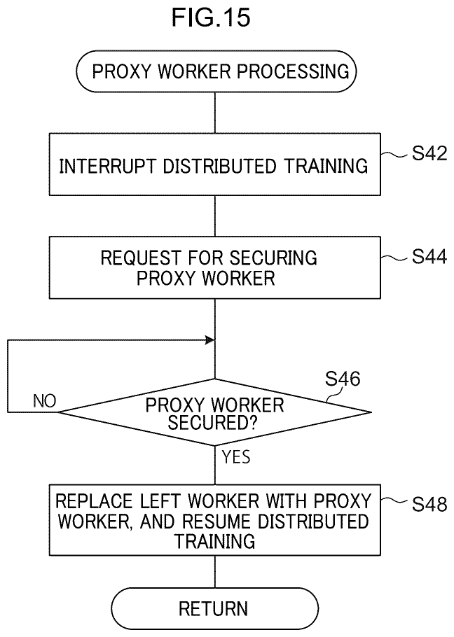

Next, proxy worker processing will be described with reference to FIG. 15.

In step S42, the control unit 46 temporarily interrupts the distributed training. Next, in step S44, the control unit 46 requests the job deployment unit 24 to secure a proxy worker. Next, in step S46, the control unit 46 determines whether or not a proxy worker has been secured. In a case in which the proxy worker has been secured, the processing proceeds to step S48, and in a case in which the proxy worker has not been secured, the processing waits until the proxy worker has been secured.

In step S48, when the proxy worker is secured, the control unit 46 replaces the left worker with the proxy worker, that is, resumes the distributed training using the remaining worker and the proxy worker, as described with reference to FIG. 6. Then, the proxy worker processing ends, and the processing returns to the distributed training processing (FIG. 13) and returns to step S12. In step S12, when the control unit 46 determines that the predetermined end condition is satisfied and the training is to be ended, the distributed training processing is ended.

As described above, the present embodiment relates to distributed training in which a plurality of workers are responsible for training processing of each of a plurality of neural networks of a multiple neural network that integrates inference results of a plurality of neural networks and outputs a final inference result. In the present embodiment, the management worker detects whether or not a failure has occurred in each of the plurality of workers. When the occurrence of a failure is detected in one or more workers among the plurality of workers, the management worker determines whether or not to cause a worker in which the occurrence of the failure is not detected among the plurality of workers to continue the distributed training. Then, in a case in which the distributed training is continued, the management worker distributes the training processing that the worker in which the failure is detected is in charge of to the worker in which the occurrence of the failure is not detected, and continues the distributed training. This makes it possible to suppress an increase in the training time of the machine learning model even when a failure occurs in a worker that executes distributed training.

Note that, in the above embodiment, a case in which the distributed training is continued by dividing the training processing of the left worker group among the remaining workers and a case in which the distributed training is continued by securing the proxy worker are selectively executed has been described, but the embodiment is not limited thereto. For example, distributed training may be continued for the remaining worker group, and securing of a proxy worker may be requested. In this case, the distributed training by the remaining worker group is continued until the proxy worker is secured. Then, a proxy worker is secured, in this case, a proxy worker is added to the remaining worker group, and the training processing of the left worker that has been shared by the remaining worker group is reassigned to the proxy worker, that is, the original state is restored, and the distributed training may be resumed.

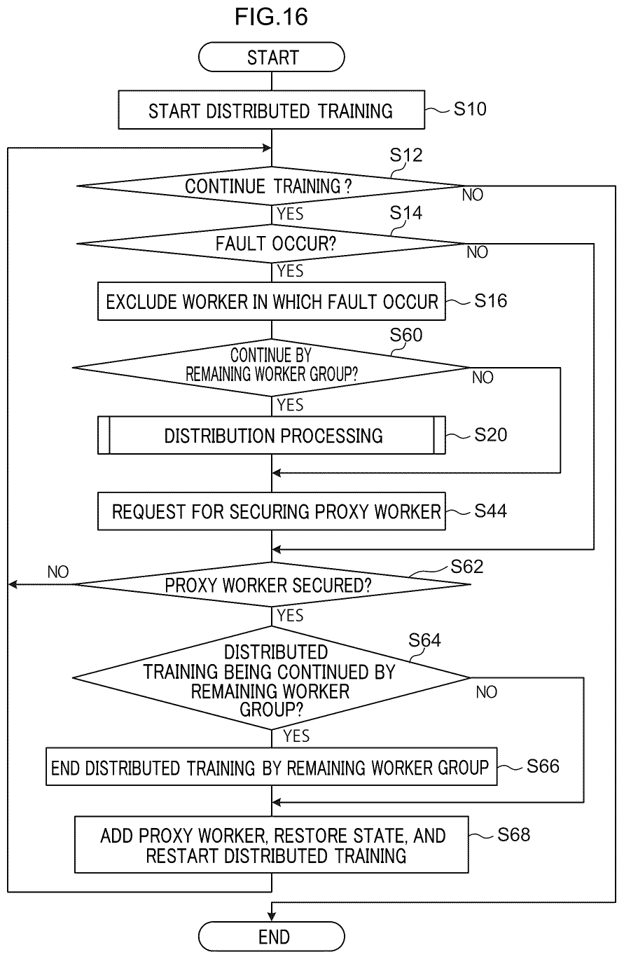

More specifically, the distributed training processing in this case will be described with reference to a flowchart illustrated in FIG. 16. Note that, in the distributed training processing illustrated in FIG. 16, the same processing as the distributed training processing (FIGS. 13 to 15) of the above-described embodiment are denoted by the same step numbers, and a detailed description thereof is omitted.

Through steps S10 to S16, in the next step S60, the determination unit 44 determines whether or not to cause the remaining worker group to continue distributed training. In a case in which the distributed training by the remaining worker group is continued, the processing proceeds to step S20, the distribution processing is executed, and then the processing proceeds to step S44. On the other hand, when the distributed training by the remaining worker group is not continued, the processing directly proceeds to step S44. In step S44, the control unit 46 requests securement of a proxy worker. Next, in step S62, the control unit 46 determines whether a proxy worker has been secured, and in a case in which a proxy worker has been secured, the processing proceeds to step S64, or in a case in which a proxy worker has not been secured, the processing returns to step S12.

In step S64, the control unit 46 determines whether or not distributed training is being continued by the remaining worker group, that is, whether or not the remaining worker group is executing distributed training by sharing the training processing of the left worker. In a case in which the distributed training by the remaining worker group is being continued, the processing proceeds to step S66, or in a case in which it is not being continued, that is, the distributed training by the initial worker group or the worker group to which a proxy worker is added is being executed, the processing proceeds to step S68.

In step S66, the control unit 46 ends the distributed training continued in the remaining worker group. Next, in step S68, the control unit 46 adds a proxy worker to the remaining worker group, restores the state, restarts the distributed training, and returns to step S12.

As described above, the distributed training by the remaining worker group is continued until the proxy worker can be secured, and when the proxy worker has been secured, the original state is restored and the distributed training is resumed, whereby the increase in the training time can be suppressed to the minimum even when a failure occurs in the worker.

Furthermore, in the above embodiment, the distributed training program is stored (installed) in the storage device in advance, but is not limited thereto. The program according to the disclosed technology may be provided in a form stored in a storage medium such as a CD-ROM, a DVD-ROM, or a USB memory.

In a case in which the same machine learning model is used by a plurality of workers and distributed training is performed in data parallelism, even if a failure occurs in one worker, training accuracy may be deteriorated, but training can be continued by the remaining workers.

However, in the case of distributed training of a multiple neural network that integrates inference results of a plurality of neural networks and outputs a final inference result, there is a problem that training cannot be continued when a failure occurs in any worker. In order to continue training, the distributed training needs to be restarted after securing a new worker in place of a worker who has left due to a failure. That is, a waiting time until preparation for a new worker occurs, and thus, in particular, in a case in which it takes time to secure a new worker, or the like, this will result in an increase in training time.

With the disclosed technology, it is possible to suppress an increase in training time of a machine learning model even when a failure occurs in a worker that executes distributed training.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory recording medium storing a program that is executable by a computer to perform a distributed training process comprising:
in distributed training in which a plurality of workers is in charge of training processing of each of a plurality of neural networks of multiple neural networks that integrate inference results of the plurality of neural networks and output a final inference result,
detecting whether or not a failure has occurred in each of the plurality of workers,
determining, when occurrence of a failure is detected in one or more first workers among the plurality of workers, whether or not to continue the distributed training using a second worker other than the first workers among the plurality of workers, and
in a case of continuing the distributed training, distributing training processing that the first worker is in charge of to the second worker, and continuing the distributed training.

2. The non-transitory recording medium of claim 1, wherein determining whether or not to continue the distributed training includes determining to continue the distributed training in a case in which a time required to secure a third worker other than the plurality of workers to be a proxy of the first worker is equal to or more than a threshold.

3. The non-transitory recording medium of claim 2, wherein the threshold is an estimated value of a training time that increases when the distributed training is continued by the second worker.

4. The non-transitory recording medium of claim 1, wherein distributing to the second worker includes setting a value obtained by dividing a batch size for each of the first workers by the number of the second workers as a batch size for the training processing that the first worker is in charge of and that is distributed to each of the second workers.

5. The non-transitory recording medium of claim 1, the process further comprising:
in a case in which it is determined that the distributed training is not to be continued using the second worker, requesting to secure a third worker other than the plurality of workers to be a proxy of the first worker, and
in a case in which the third worker is secured, resuming the distributed training using the second worker and the secured third worker.

6. The non-transitory recording medium of claim 1, the process further comprising:
causing the second worker to continue the distributed training, and requesting to secure a third worker other than the plurality of workers to be a proxy of the first worker; and
in a case in which the third worker is secured, reallocating the training processing of the first worker distributed to the second worker to the secured third worker, and resuming the distributed training.

7. A distributed training method comprising:
by a processor,
in distributed training in which a plurality of workers is in charge of training processing of each of a plurality of neural networks of multiple neural networks that integrate inference results of the plurality of neural networks and output a final inference result,
detecting whether or not a failure has occurred in each of the plurality of workers,
determining, when occurrence of a failure is detected in one or more first workers among the plurality of workers, whether or not to continue the distributed training using a second worker other than first workers among the plurality of workers, and
in a case of continuing the distributed training, distributing training processing that the first worker is in charge of to the second worker, and continuing the distributed training.

8. The distributed training method of claim 7, wherein determining whether or not to continue the distributed training includes determining to continue the distributed training in a case in which a time required to secure a third worker other than the plurality of workers to be a proxy of the first worker is equal to or more than a threshold.

9. The distributed training method of claim 8, wherein the threshold is an estimated value of a training time that increases when the distributed training is continued by the second worker.

10. The distributed training method of claim 7, wherein distributing to the second worker includes setting a value obtained by dividing a batch size for each of the first workers by the number of the second workers as a batch size for the training processing that the first worker is in charge of and that is distributed to each of the second workers.

11. The distributed training method of claim 7, further comprising:
in a case in which it is determined that the distributed training is not to be continued using the second worker, requesting to secure a third worker other than the plurality of workers to be a proxy of the first worker, and
in a case in which the third worker is secured, resuming the distributed training using the second worker and the secured third worker.

12. The distributed training method of claim 7, further comprising:
causing the second worker to continue the distributed training, and requesting to secure a third worker other than the plurality of workers to be a proxy of the first worker; and
in a case in which the third worker is secured, reallocating the training processing of the first worker distributed to the second worker to the secured third worker, and resuming the distributed training.

13. A distributed training device comprising:
a memory; and
a processor coupled to the memory, the processor being configured to execute processing, the processing including:
in distributed training in which a plurality of workers is in charge of training processing of each of a plurality of neural networks of multiple neural networks that integrate inference results of the plurality of neural networks and output a final inference result,
detecting whether or not a failure has occurred in each of the plurality of workers,
determining, when occurrence of a failure is detected in one or more first workers among the plurality of workers, whether or not to continue the distributed training using a second worker other than first workers among the plurality of workers, and
in a case of continuing the distributed training, distributing training processing that the first worker is in charge of to the second worker, and continuing the distributed training.

14. The distributed training device of claim 13, wherein, in the processing:
determining whether or not to continue the distributed training includes determining to continue the distributed training in a case in which a time required to secure a third worker other than the plurality of workers to be a proxy of the first worker is equal to or more than a threshold.

15. The distributed training device of claim 14, wherein, in the processing:
the threshold is an estimated value of a training time that increases when the distributed training is continued by the second worker.

16. The distributed training device of claim 13, wherein, in the processing:
distributing to the second worker includes setting a value obtained by dividing a batch size for each of the first workers by the number of the second workers as a batch size for the training processing that the first worker is in charge of and that is distributed to each of the second workers.

17. The distributed training device of claim 13, the processing further comprising:
in a case in which it is determined that the distributed training is not to be continued using the second worker, requesting to secure a third worker other than the plurality of workers to be a proxy of the first worker, and
in a case in which the third worker is secured, resuming the distributed training using the second worker and the secured third worker.

18. The distributed training device of claim 13, the processing further comprising:
causing the second worker to continue the distributed training, and requesting to secure a third worker other than the plurality of workers to be a proxy of the first worker; and
in a case in which the third worker is secured, reallocating the training processing of the first worker distributed to the second worker to the secured third worker, and resuming the distributed training.
